(19) United States
(12) Patent Application Publication
(10) Pub. No.: US 2014/0005934 A1
(43) Pub. Date: Jan. 2, 2014

(54) Incorporating Traveler Feedback in Future Trip Planning

(71) Applicants: Gee Ngoo Chia, Morrisville, NC (US); Christopher Michael Laffoon, Durham, NC (US); Viswanath Srikanth, Chapel Hill, NC (US); Wai Man Yau, Charlotte, NC (US)

(72) Inventors: Gee Ngoo Chia, Morrisville, NC (US); Christopher Michael Laffoon, Durham, NC (US); Viswanath Srikanth, Chapel Hill, NC (US); Wai Man Yau, Charlotte, NC (US)

(73) Assignee: International Business Machines Corporation, Armonk, NY (US)

(21) Appl. No.: 13/537,091

(22) Filed: Jun. 29, 2012

(51) Int. Cl. G01C 21/00

(52) U.S. Cl. 701/450

(57) ABSTRACT

An approach is provided to selectively incorporate traveler feedback into a trip planning database. In the approach, a planned trip segment is retrieved with the planned trip segment including a planned start time, a planned start location, a planned mode of transportation, a planned destination location, and a predicted end time. Subsequently, actual trip segment data items are received. A validation routine checks whether the planned trip segment was actually traveled by comparing the retrieved planning trip segment with the actual trip segment data items. If the trip is successfully validated, then the trip planning database is updated using feedback received from the user. However, if validation was unsuccessful, then the trip planning database not updated with the user's travel feedback.

### TECHNICAL FIELD

The present disclosure relates to an approach that gathers feedback from a traveler and incorporates gathered feedback into future trip planning activities.

### BACKGROUND OF THE INVENTION

After a traveler has taken a trip that was planned using a computer-based multi-modal trip planning tool, the information regarding the traveler's experience is not efficiently collected using traditional trip planning tools. Traditional tools do not provide a systematic approach in determining whether this experience data on a given route should be utilized when recommending future routes. For example, the traveler might use a different public transit option than was specified by the trip plan. Many multi-modal trip planners include private transportation (i.e. a traveler's own vehicle) as possible route options. However, traditional trip planning tools fail to verify that the traveler actually took this mode of transportation nor do these traditional tools identify whether the traveler correctly followed given travel directions.

### SUMMARY

An approach is provided to selectively incorporate traveler feedback into a trip planning database. In the approach, a planned trip segment is retrieved with the planned trip segment including a planned start time, a planned start location, a planned mode of transportation, a planned destination location, and a predicted end time. Subsequently, actual trip segment data items are received. A validation routine checks whether the planned trip segment was actually traveled by comparing the retrieved planning trip segment with the actual trip segment data items. If the trip is successfully validated, then the trip planning database is updated using feedback received from the user. However, if validation was unsuccessful, then the trip planning database is not updated with the user's travel feedback.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing a user's trip divided into trip segments with the system monitoring the user's trip using feedback provided during the various trip segments;

FIG. 4 is a flowchart showing steps taken to plan a trip using a trip planning approach that utilizes user feedback;

FIG. 5 is a flowchart showing steps taken by the system in monitoring a user's trip while the user is traveling; and

FIG. 6 is a flowchart showing steps taken by the system to analyze the trip segments to identify segments that were taken by the user as planned during the initial trip planning.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The following detailed description will generally follow the summary of the disclosure, as set forth above, further explaining and expanding the definitions of the various aspects and embodiments of the disclosure as necessary.

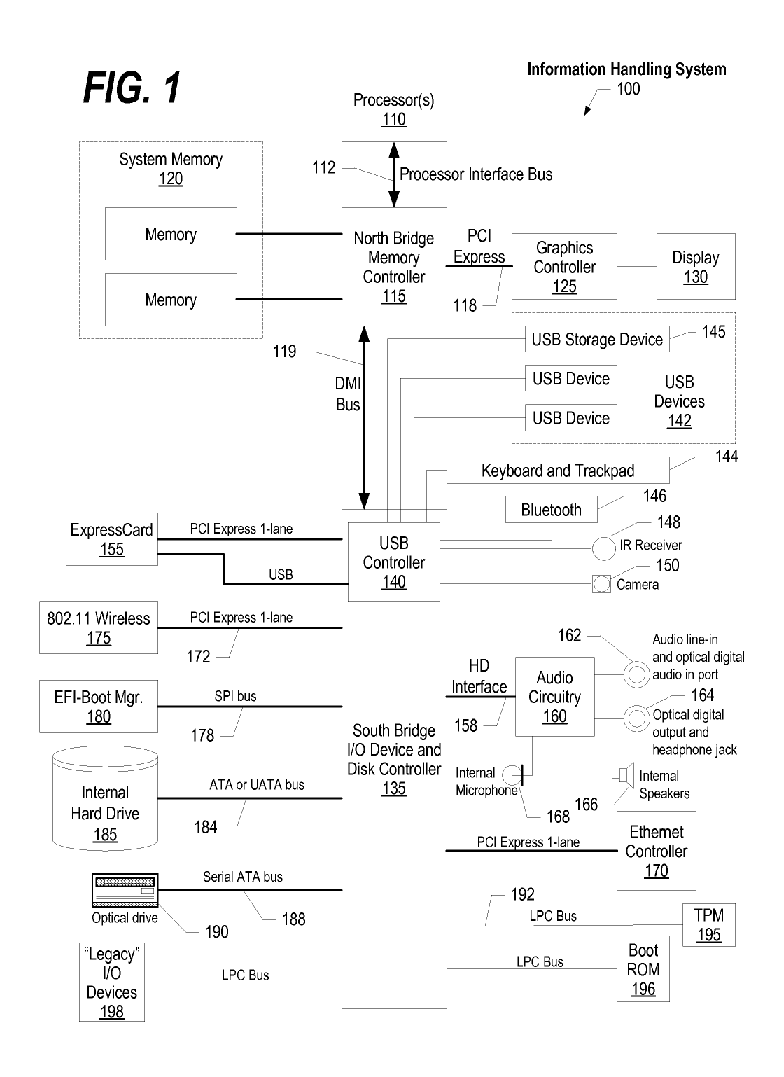

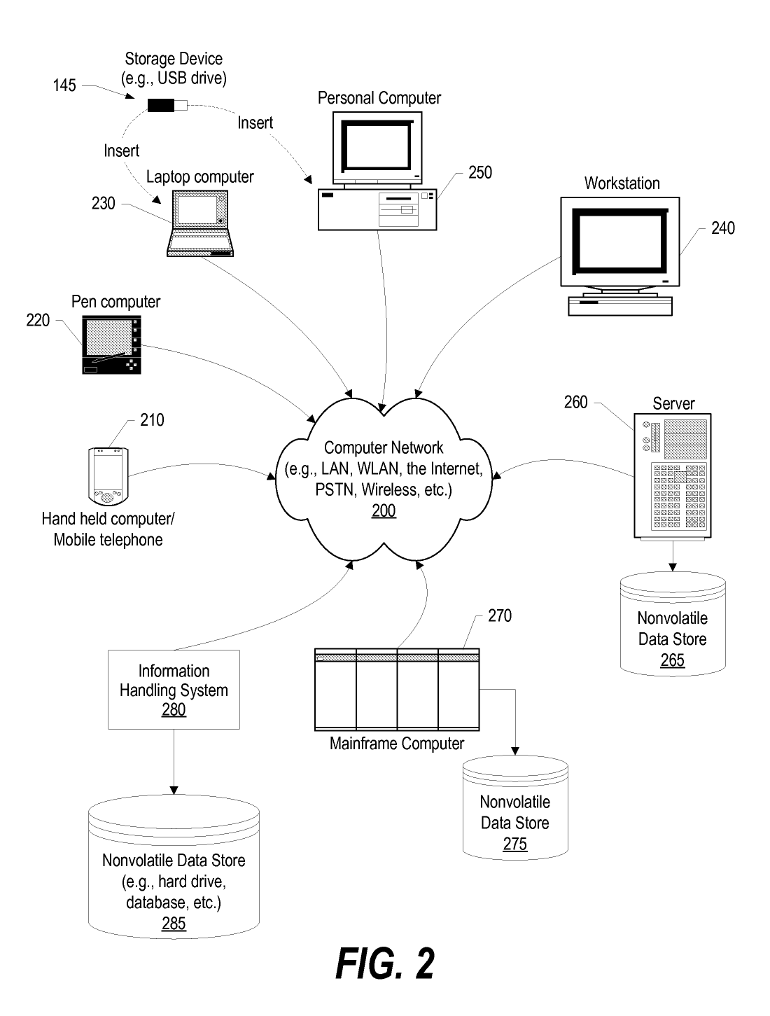

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

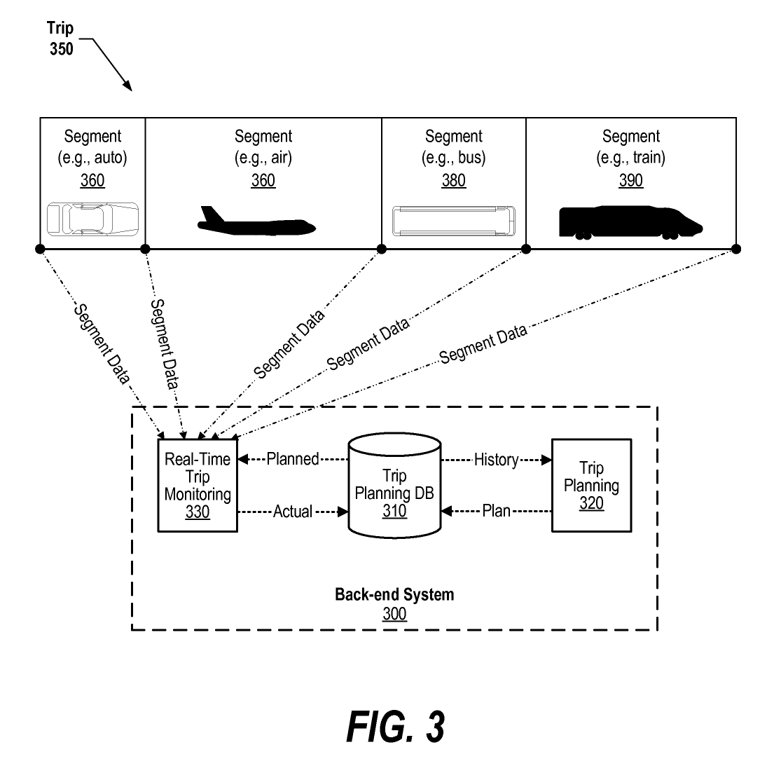

FIGS. 3-6 depict an approach that can be executed on an information handling system and computer network as shown in FIGS. 1-2. The approached described herein defines a trip plan as a sequence of segments and provides specific criteria that are be met in order for each segment to be evaluated as intentionally and correctly taken by the traveler according to the given plan. The results of this analysis can then be used to determine whether this user's subjective and other feedback on each segment of a trip should be incorporated in future trip plans. A exemplary system that implements this system includes the use of a GPS-enabled mobile device in the hands of a traveler throughout the trip, a set of mobile applications, GPS transmitters on transit vehicles, and a back-end system that processes traveler experience data and vehicle GPS locations. This approach allows trip planners to determine the applicability of traveler experience data and feedback by knowing whether a particular traveler's experience is relevant to the plan that was given. Moreover, this approach enables systems, like the information handling system disclosed herein, to automate the collection and processing of complex user travel experience data.

FIG. 3 is a diagram showing a user's trip divided into trip segments with the system monitoring the user's trip using feedback provided during the various trip segments. Back-end system 300 maintains trip planning database 310 that is updated with traveler feedback upon validation that the traveler actually traveled the planned route using the planned mode of transportation. In this manner, erroneous, or irrelevant, data is filtered out of trip planning database 310 which can make the trip planning more reliable during trip planning processes (process 320). Monitoring process 330 receives actual trip data (trip segment data) and compares the actual trip data with the planned trip data to validate that the planned trip was actually taken.

A traveler's trip is divided into one or more segments. For example, in the example shown in FIG. 3, a traveler is taking a four-segment trip (trip 350). First segment 360, such as a private automobile mode of transportation from the user's office to the airport. Second segment 370 is shown as an air segment where the traveler takes a commercial airline from the airport to a destination airport. In the third segment 380, the traveler is taking a public mode of transportation, such as a bus, from the destination airport to a train station. The final segment 390, shows the traveler taking a train from a first train station to a destination train station. As shown, wireless devices such as Bluetooth devices, GPS-enabled devices, smart-phone devices, and other mobile information handling system are used to gather near real-time actual trip segment data items and transmit such items to real time trip monitoring process 330. Validation is performed by comparing the actual trip segment data items to the planned trip segment in order to determine whether the user (traveler) actually took the planned travel.

For example, in the example, once the traveler reached the destination airport, he may have chosen to take a taxi to the train station rather than take the planned bus. When the traveler provides feedback about this segment of the trip, the feedback is actually regarding an unplanned mode of transportation (the taxi) rather than the planned mode of transportation (the bus), so feedback (negative or positive) should not be related to the bus. Actual trip segment data is gathered, as shown, at the beginning and at the ending of the various trip segments. In addition, actual trip segment data can be gathered during the actual trip segment to ensure that the route actually being taken is the same as the planned route. For example, during the first segment 360 when the user drives to the airport, the user may decide to take a scenic, longer, route rather than the planned route that uses express lanes. Feedback from the user regarding this segment (“took longer than expected,” “beautiful scenery,” etc.) would not be used by the system when it is discovered, during validation, that the user did not take the planned route.

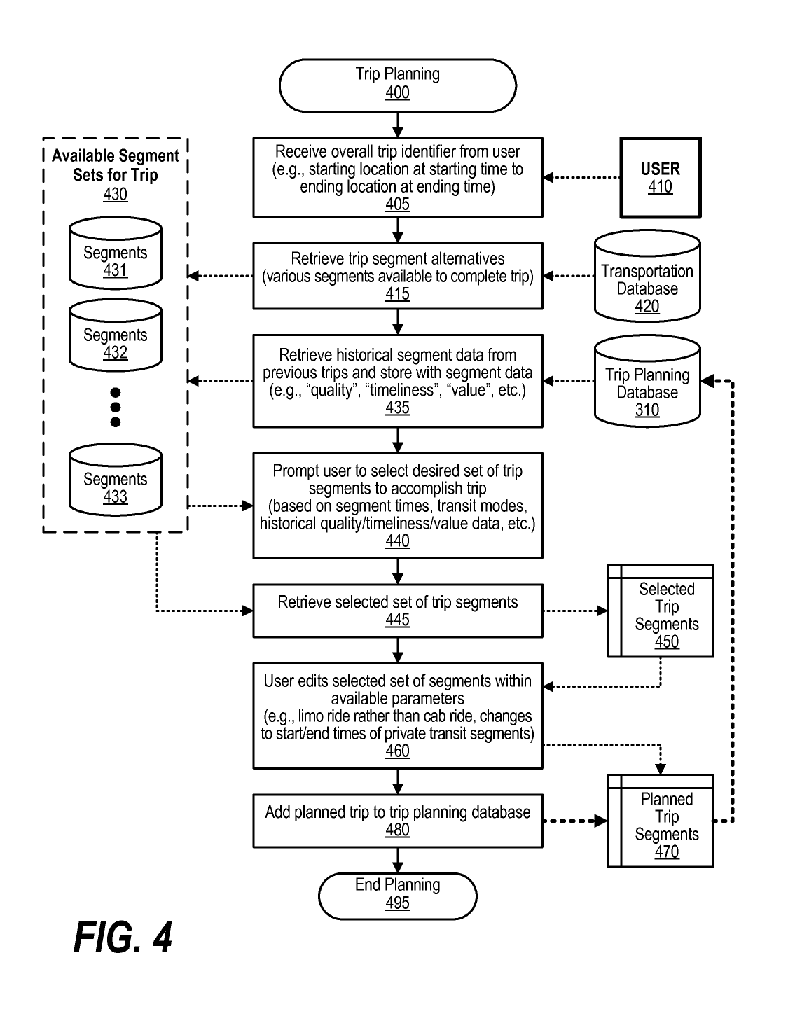

FIG. 4 is a flowchart showing steps taken to plan a trip using a trip planning approach that utilizes user feedback. Trip planning processing commences at 400 whereupon, at step 405, the trip planning process receives an overall trip identifier (e.g., “NY to Calif.,” etc.) along with a planned departure date/time and/or a planned arrival date/time. At step 415, the trip planning process retrieves possible trip segment alternatives from transportation database 420 with the possible trip segment alternatives providing various segments that allow the user to travel from the departure location at or near the desired departure data/time to the destination location at or near the desired arrival date/time. The retrieved segments are shown as available segments 430 and include various sets of segments (segments 431, 432, 433) that provide different transportation options that allow the traveler to travel from the departure location to the destination location at or near the desired data and time.

At step 435, historical segment data are retrieved from trip planning database 310 reflecting feedback from this traveler and other travelers having taken previous trips using the various segments that were retrieved at step 415. The historical segment data provides qualitative feedback data so that the traveler can compare feedback that has been provided and select segments that are suitable to the traveler's needs and desires. For example, a previous traveler may have taken a particular bus route and complained that the bus was dirty, overcrowded, and was not air conditioned. The user might then decide to take a different segment that travels from the same departure location to the same destination location but had better feedback, such as a train that was reported as being clean, smooth, and comfortable.

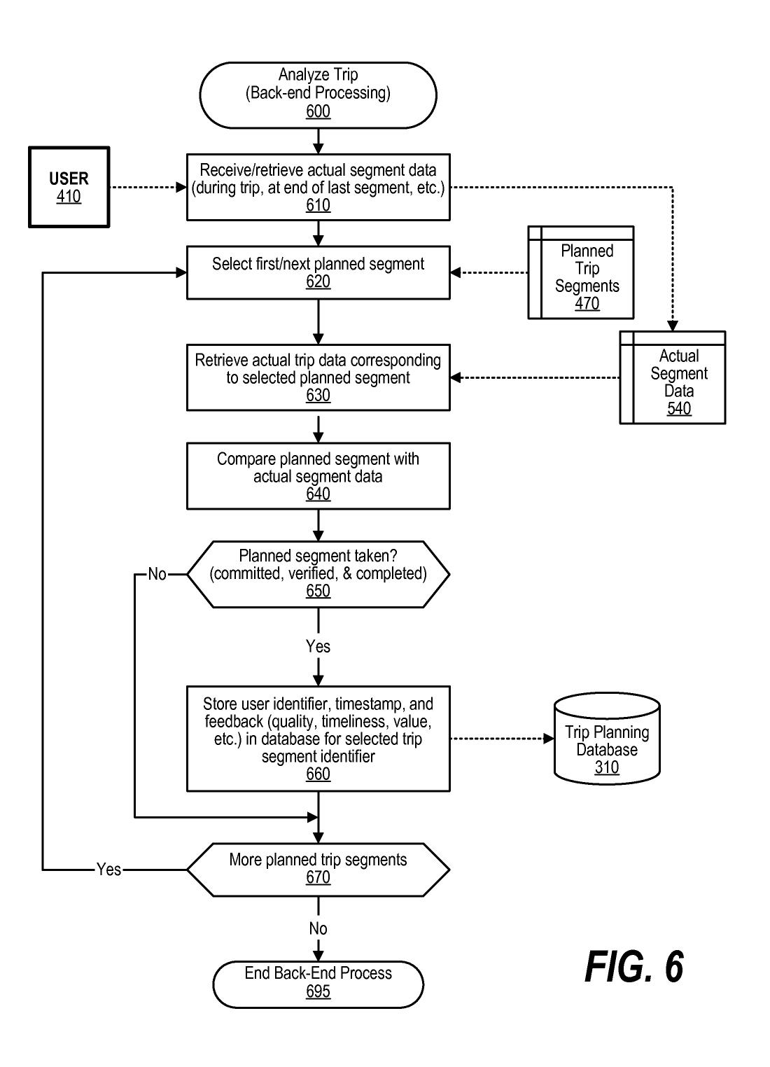

At step 440, the user is prompted to select a desired set of trip segments to accomplish the overall trip. The user's decision is now based on planned segment details (e.g., planned start time, planned start location, planned mode of transportation, planned destination location, etc.) as well as qualitative feedback data provided by various travelers who previously traveled these trip segments. As shown in FIG. 6, the trip planning database is updated using feedback from travelers when the system has validated that the travelers actually took the planned trip segment. In this manner, the qualitative feedback data upon which the user is relying is generally better than in a system where such validation is not performed and the previous traveler may have been reporting his or her feedback on an entirely different travel segment experience (e.g., different mode of transportation used, etc.).

At step 445, the system retrieves the details regarding the planned trip segments selected by the user and stores the details in selected trip segments memory area 450. At step 460, the user is provided an opportunity to edit particular planned trip segments within available parameters. For example, the user may decide to hire a limousine rather than take a cab ride from the airport to the user's hotel and may decide to alter the planned start and end times of private mode of transportation segments, such as to allow time for a meal, etc. After any editing of selected trip segments has been performed, at step 480, the user's planned trip, stored in memory area 470 and which is a collection of planned trip segments, is added to trip planning database 310 so that the trip can be monitored and validated when the user actually takes the planned trip. Planning processing thereafter ends at 495.

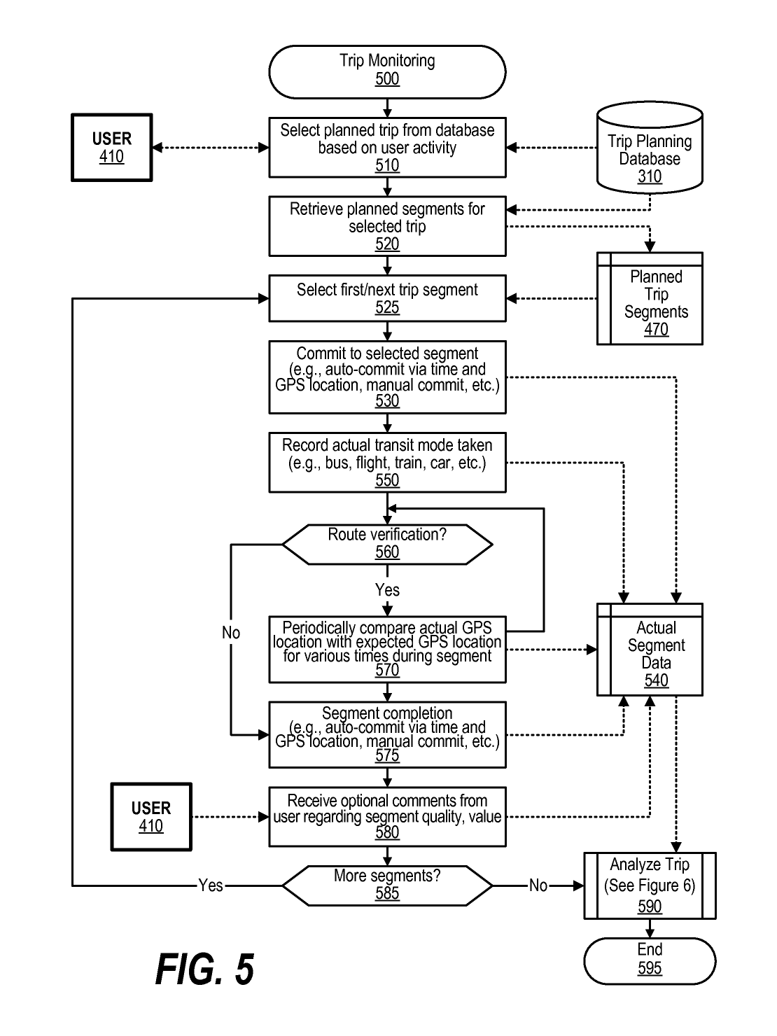

FIG. 5 is a flowchart showing steps taken by the system in monitoring a user's trip while the user is traveling. Monitoring process commences at 500 whereupon, at step 510, a planned trip is selected from trip planning database 310 based on an activity performed by user 410 (e.g., the user is at the planned departure location at or near the planned departure time for the first segment in the planned trip, etc.). At step 520, the monitoring process retrieves the planned trip segments corresponding to the plan trip that was selected at step 510. The planned trip segments are stored in planned trip segments memory area 470. A loop is commenced starting with the first planned trip segment and ending with the last planned trip segment.

At step 525, the first planned trip segment is selected from planned trip segments memory area 470. At some point, shown as step 530, the user (traveler) commits to the selected segment with the commitment either occurring manually (e.g., the user sends a signal to the back-end system that he is beginning the trip segment, etc.) or automatically (e.g., the user is at the planned start location as indicated via a GPS-enabled device at or near the planned start time as indicated at a clock of the back-end system (accounting for the user potentially being in a different time zone than where the monitoring back-end system is located). The segment commitment is stored as an actual trip segment data item in memory area 540. At step 550, the actual mode of transportation is identified either manually by the user (e.g., providing the mode of transportation identifier (bus route number, private car, etc.) to the back-end system), or automatically (e.g., by a wireless transmitter in the mode of transportation, such as a Bluetooth device, transmitting the mode of transportation identifier to the user's handheld device, such as a smart phone, which relays the received mode of transportation identifier back to the back-end system). The actual mode of transportation is stored as an actual trip segment data item in memory area 540.

A decision is made as to whether route verification is available for the selected trip segment (decision 560). A GPS-enabled device, such as a hand-held device belonging to the user or a GPS-enabled device incorporated in a vehicle may be used to provide route verification. In addition, commercial airline route data is often made available by the airlines. If route verification is being performed for the selected trip segment, then decision 560 branches to the “yes” branch whereupon, at step 570, an actual location and time is periodically retrieved and stored as an actual trip segment data item in memory area 540. Processing then loops back to periodically gather the actual position on the route at various times throughout the actual trip segment. This looping continues until the actual trip segment is completed. Returning to decision 560, if route verification is not enabled or being performed for the selected trip segment, then decision 560 branches to the “no” branch bypassing step 570.

When the actual trip segment is complete, then, at step 575, actual trip segment data items pertaining to segment completion are gathered and stored in actual segment data memory area 540. Actual trip segment data items pertaining to segment completion include the actual arrival time, the actual destination location, and the actual mode of transportation. These segment completion data items can be used to validate that the user did not change modes of transportation (e.g., started on a bus but completed segment in a taxi, etc.), did not take significant delays or detours (e.g., made unplanned stop along segment route to go shopping, etc.), and did not decide to go to a different location (e.g., started driving to Oakland but drove instead to San Francisco, etc.).

At step 580, optional comments (feedback) regarding qualitative and other aspects of the actual trip segment are received from the user and stored in actual segment data memory area 540. For example, the quality and comfort of a train ride, airplane ride, etc. As will be seen in FIG. 6, this feedback data is used to update the trip planning database once the user's planned trip segment is validated by comparing the planning trip segment details with the actual trip segment data items gathered and stored in memory area 540. However, if validation is unsuccessful (e.g., the user did not travel on the planned route, using the planned mode of transportation, etc.), then the back-end system prevents the trip planning database from being updated with the user's feedback data as such feedback data may be unreliable or not reflect the planned trip segment.

A decision is made as to whether there are more planned trip segments corresponding to the trip that is being taken by the user (decision 585). If there are more planned trip segments, then decision 585 branches to the “yes” branch which loops back to select and process the next trip segment in the trip. This looping continues until all segments of the trip have been taken, at which point decision 585 branches to the “no” branch. At predefined process 590, the trip taken by the user is analyzed by a back-end trip analyzer that validates the various trip segments in order to selectively incorporate the user's feedback into the trip planning database. The monitoring process thereafter ends at 595.

FIG. 6 is a flowchart showing steps taken by the system to analyze the trip segments to identify segments that were taken by the user as planned during the initial trip planning. Back-end processing commences at 600 whereupon, at step 610, the back-end process receives actual trip segment data items (memory area 540) reflecting the actual mode of transportation, starting times and locations, ending times and locations, and route data actually taken by user 400 (the traveler) during the user's travels.

At step 620, the first planned trip segment is retrieved from planned trip segments memory area 470 with the planned trip segment detailing the planned start time, planned start location, planned mode of transportation, planned destination location, and predicted end time. In one embodiment, if route verification is being performed, the planned trip segment also includes detailed planned route data. At step 630, the actual trip segment data items corresponding to the selected planned segment are retrieved. The actual trip segment data items include the actual start time, actual start location, actual mode of transportation, actual destination location, and actual arrival time.

At step 640, the selected planned segment details are compared to the actual trip segment data items to validate that the selected planned trip segment was actually traveled by the user. A decision is made as to whether the planned trip segment was successfully validated (decision 650). If the planned trip segment was successfully validated, then decision 650 branches to the “yes” branch whereupon, at step 660, trip planning database 310 is updated with feedback received from the user regarding the planned trip segment. Such feedback may include quality, conditions, timeliness, value, etc. and may be useful to users when deciding whether to take the planned trip segment in future trips.

On the other hand, if the planned trip segment was not successfully validated (unsuccessful validation), then decision 650 branches to the “no” branch bypassing step 660. Bypassing step 660 prevents the back-end process from updating the trip planning database with any feedback received from the user in the case of an unsuccessful validation of the selected planned trip segment.

A decision is made as to whether there were more planned trip segments for the trip that was taken by the user (decision 670). If there were more planned trip segments, then decision 670 branches to the “yes” branch which loops back to select the next planned trip segment in the trip and validate the next selected trip segment as described above. This looping continues until all segments of the trip have been selected and processed, at which point decision 670 branches to the “no” branch and back-end processing ends at 695.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of selectively incorporating traveler feedback into a trip planning database, the method, implemented by an information handling system, comprising:
retrieving a planned trip segment corresponding to a user;
receiving a plurality of actual trip segment data items, wherein the actual trip segment data items correspond to the planned trip segment;
validating that the planned trip segment was traveled by comparing the retrieved planning trip segment with the received plurality of actual trip segment data items;
updating the trip planning database with a feedback received from the user regarding the planned trip segment in response to a successful validation; and
preventing the updating of the trip planning database using the user's feedback in response to an unsuccessful validation.

2. The method of claim 1 wherein the validating further comprises:
verifying a set of destination information included in the received actual trip segment data items that correspond to the user, wherein the set of destination information includes an actual arrival time, an actual destination location, and an actual mode of transportation; and
comparing the actual arrival time with the predicted end time, the actual destination location with the planned destination location, and the actual mode of transportation with the planned mode of transportation.

3. The method of claim 1 wherein the planned trip segment includes a planned segment route, and wherein the validating further comprises:
receiving a plurality of actual periodic GPS locations during the travel of the actual trip segment; and
comparing the received plurality of actual periodic GPS locations with the planned segment route.

4. The method of claim 1 wherein the validating further comprises:
verifying a set of origin information included in the received actual trip segment data items that correspond to the user, wherein the set of origin information includes an actual start time, an actual start location, and an actual mode of transportation; and
comparing the actual start time with a planned start time, the actual start location with a planned start location, and the actual mode of transportation with a planned mode of transportation.

5. The method of claim 4 further comprising:
receiving a geo-point identifier from a device proximate to the user, wherein the geo-point identifier corresponds to the actual start location; and
retrieving a current timestamp in response to the reception of the geo-point identifier, wherein the current timestamp corresponds to the actual start time.

6. The method of claim 3 wherein the device from which the geo-point identifier is received is a GPS-enabled device that provides user geo-point verification.

7. The method of claim 4 further comprising:
receiving a identifier from a wireless communications device incorporated in the actual mode of transportation, wherein the identifier identifies a type of the actual mode of transportation; and
comparing the received type of the actual mode of transportation with a planned mode of transportation.

8. An information handling system comprising:
one or more processors;
a memory coupled to at least one of the processors;
a nonvolatile storage area accessible by at least one of the processors; and
a set of instructions stored in the memory and executed by at least one of the processors to selectively incorporate traveler feedback into a trip planning database, wherein the set of instructions perform actions of:
retrieving a planned trip segment corresponding to a user;
receiving a plurality of actual trip segment data items, wherein the actual trip segment data items correspond to the planned trip segment;
validating that the planned trip segment was traveled by comparing the retrieved planning trip segment with the received plurality of actual trip segment data items;
updating the trip planning database with a feedback received from the user regarding the planned trip segment in response to a successful validation; and
preventing the updating of the trip planning database using the user's feedback in response to an unsuccessful validation.

9. The information handling system of claim 8 wherein the validating further comprises:
verifying a set of destination information included in the received actual trip segment data items that correspond to the user, wherein the set of destination information includes an actual arrival time, an actual destination location, and an actual mode of transportation; and
comparing the actual arrival time with the predicted end time, the actual destination location with the planned destination location, and the actual mode of transportation with the planned mode of transportation.

10. The information handling system of claim 8 wherein the planned trip segment includes a planned segment route, and wherein the validating further comprises:
receiving a plurality of actual periodic GPS locations during the travel of the actual trip segment; and
comparing the received plurality of actual periodic GPS locations with the planned segment route.

11. The information handling system of claim 8 wherein the validating further comprises:
verifying a set of origin information included in the received actual trip segment data items that correspond to the user, wherein the set of origin information includes an actual start time, an actual start location, and an actual mode of transportation; and
comparing the actual start time with a planned start time, the actual start location with a planned start location, and the actual mode of transportation with a planned mode of transportation.

12. The information handling system of claim 11 wherein the set of instructions perform additional actions comprising:
receiving a geo-point identifier from a GPS-enabled device proximate to the user, wherein the geo-point identifier corresponds to the actual start location; and
retrieving a current timestamp in response to the reception of the geo-point identifier, wherein the current timestamp corresponds to the actual start time.

13. The information handling system of claim 11 wherein the set of instructions perform additional actions comprising:
receiving a identifier from a wireless communications device incorporated in the actual mode of transportation, wherein the identifier identifies a type of the actual mode of transportation; and
comparing the received type of the actual mode of transportation with a planned mode of transportation.

14. A computer program product stored in a computer readable medium, comprising computer instructions that, when executed by an information handling system, causes the information handling system to selectively incorporating traveler feedback into a trip planning database by performing actions comprising:
retrieving a planned trip segment corresponding to a user;
receiving a plurality of actual trip segment data items, wherein the actual trip segment data items correspond to the planned trip segment;
validating that the planned trip segment was traveled by comparing the retrieved planning trip segment with the received plurality of actual trip segment data items;
updating the trip planning database with a feedback received from the user regarding the planned trip segment in response to a successful validation; and
preventing the updating of the trip planning database using the user's feedback in response to an unsuccessful validation.

15. The computer program product of claim 14 wherein the validating further comprises:
verifying a set of destination information included in the received actual trip segment data items that correspond to the user, wherein the set of destination information includes an actual arrival time, an actual destination location, and an actual mode of transportation; and
comparing the actual arrival time with the predicted end time, the actual destination location with the planned destination location, and the actual mode of transportation with the planned mode of transportation.

16. The computer program product of claim 14 wherein the planned trip segment includes a planned segment route, and wherein the validating further comprises:
receiving a plurality of actual periodic GPS locations during the travel of the actual trip segment; and
comparing the received plurality of actual periodic GPS locations with the planned segment route.

17. The computer program product of claim 14 wherein the validating further comprises:
verifying a set of origin information included in the received actual trip segment data items that correspond to the user, wherein the set of origin information includes an actual start time, an actual start location, and an actual mode of transportation; and
comparing the actual start time with a planned start time, the actual start location with a planned start location, and the actual mode of transportation with a planned mode of transportation.

18. The computer program product of claim 17 wherein the actions further comprise:
receiving a geo-point identifier from a device proximate to the user, wherein the geo-point identifier corresponds to the actual start location; and
retrieving a current timestamp in response to the reception of the geo-point identifier, wherein the current timestamp corresponds to the actual start time.

19. The computer program product of claim 18 wherein the device from which the geo-point identifier is received is a GPS-enabled device that provides user geo-point verification.

20. The computer program product of claim 17 wherein the actions further comprise:
receiving a identifier from a wireless communications device incorporated in the actual mode of transportation, wherein the identifier identifies a type of the actual mode of transportation; and
comparing the received type of the actual mode of transportation with a planned mode of transportation.
